(19) United States
(12) Patent Application Publication
(10) Pub. No.: US 2015/0218822 A1
(43) Pub. Date: Aug. 6, 2015

(54) COMPOSITE SOLAR ROOF

(71) Applicant: Wade BLAZLEY, Carcoar, NSW (AU)

(72) Inventor: Wade Blazley, Carcoar (AU)

(21) Appl. No.: 14/425,274

(22) PCT Filed: Sep. 3, 2013
(86) PCT No.: PCT/AU2013/000994

§ 371 Date: Mar. 2, 2015

(30) Foreign Application Priority Data
Sep. 3, 2012 (AU) 2012903820
Oct. 11, 2012 (AU) 2012904450

(51) Int. Cl. E04D 3/40; H02S 20/23; E04D 3/361; E04D 3/16; E04D 3/18

(52) U.S. Cl. CPC E04D 3/40; E04D 3/16; E04D 3/18; E04D 3/361; H02S 20/23

(57) ABSTRACT

The present invention rafales broadly to—a solar roof assembly (100) comprising—roof cladding (120) and a plurality of solar panels such as (140A and 140B). The roof cladding (120) includes a series of adjacent channels such as (160A to 160C). The solar panels (140A and 140B) are secured directly to the roof cladding (120) to substantially enclose the channels (160A to 160C). The solar panels (140A and 140B) include a thin film PV membrane (102A) applied to a rigid panel backing (104A).

### FIELD OF THE INVENTION

The present invention relates broadly to a solar roof assembly and a method of insulating a roof The invention also relates generally to a method of heating or cooling a building having roof cladding.

### BACKGROUND TO THE INVENTION

In a commercial roof structure of a conventional construction, transverse purlins extend across a series of parallel beams for a flat roof, or a series of parallel rafters for a pitched roof. The roof structure is typically clad in corrugated sheeting to enclose the structure. In order to thermally insulate the corrugated sheeting, sarking is layered across the purlins or rafters prior to fixing of the roof cladding. The root structure may also be thermally insulated with the addition of insulation between the purlins or rafters.

### SUMMARY OF THE INVENTION

According to one aspect of the invention there is provided a solar roof assembly comprising:
roof cladding including at least one channel;
a plurality of solar panels secured directly to the roof cladding to substantially enclose said at least one channel for at least partial coverage of the roof cladding, each of the solar panels including a rigid panel backing to which a photovoltaic membrane or coating is applied.

Preferably the rigid panel backing includes an intermediate pan located between opposing ridges wherein the panel backing is secured directly to the roof cladding with said ridges disposed transverse to the channel of the roof cladding thereby cross-bracing it. More preferably the adjacent solar panels lap one another and are both screw fastened to the roof cladding via a common screw fastener. Still more preferably the PV membrane or coating extends across at least substantially all of the pan of the rigid panel backing.

According to another aspect of the invention there is provided a solar roof assembly comprising:
roof cladding including at least one channel;
a plurality of solar panels secured directly to the roof cladding to substantially enclose said at least one channel for at least partial coverage of the roof cladding;
a plurality of securement devices each including a hold down fitting configured to engage a perimeter frame of at least one of solar panels, and a fastening arrangement configured to engage the roof cladding without penetration and operatively coupled to the hold down fitting for clamping of the solar panel directly to the roof cladding.

According to a further aspect of the invention there is provided a method of insulating a roof having roof cladding, said method comprising the steps of:
securing a plurality of solar panels directly to the roof cladding to substantially enclose channels of the roof cladding for at least partial coverage of said roof cladding;
damping each of the solar panels directly to the roof cladding via a securement device without penetration of the roof cladding.

Preferably the solar panels are each solar photovoltaic (PV) panels having a toughened glass upper layer. More preferably the solar PV panels are secured to the roof cladding in one or more rows located alongside one another and oriented substantially transverse to the channels of the roof cladding. Even more preferably adjacent rows of the solar panels are staggered relative to one another.

Preferably the solar panel acts as a cross-brace for the cladding panel to which it is secured. More preferably the cross-brace bridges and is oriented transverse to the channel of the roof cladding.

Preferably the plurality of solar panels together with the roof cladding define a still air gap within said at least one channel. More preferably the still air gap has a thermal insulating effect for the solar roof assembly.

Preferably the roof cladding includes a plurality of elongate cladding panels each including said at least one channel with adjacent of the panels being adjoined to one another. More preferably each of the cladding panels includes a pair of inclined side walls interconnected by an intermediate pan. Even more preferably the cladding panels are each in cross-section generally trapezoidal-shaped.

Preferably the cladding panels each include a flange extending from a free edge margin of respective of the side walls. More preferably adjacent of the flanges of adjoining panels are configured to interlock. Even more preferably one of the interlocked flanges forms a platform on which the solar panel rests.

According to still another of the invention there is provided a securement device for securing a solar panel directly to roof cladding, the securement device comprising:
a hold down fitting adapted to engage a perimeter frame of the solar panel;
a fastening arrangement adapted to engage the roof cladding without penetration and operatively coupled to the hold down fitting for clamping the solar panel directly to the roof cladding.

Preferably the fastening arrangement includes a screw threaded bolt arranged at its head to engage the hold down fitting and arranged at its threaded end to screw threadably engage a cleat configured to engage the roof cladding. More preferably the cleat includes a raised flange arranged to engage interlocked flanges of adjoining cladding panels for clamping of the solar panel to said cladding panels.

According to yet another aspect of the invention there is provided a method of heating or cooling a building having roof cladding, said method comprising the steps of:
securing a plurality of solar panels directly to the roof cladding to substantially enclose channels of the roof cladding for at least partial coverage of said roof cladding;
extracting air from at least one of the enclosed channels of the roof cladding for heating or cooling of the building.

Preferably the method of heating or cooling also comprises the step of diverting the extracted air into an enclosed space of the building for heating of the enclosed space. More preferably the method further comprises the steps of:
detecting the temperature in the enclosed space of the building;
diverting the extracted air into either:
(i) the atmosphere in the event that the detected temperature is above a predetermined set point temperature; or
(ii) the enclosed space of the building in the event that the detected temperature is below the set point temperature.

Preferably the roof cladding is fabricated from metal and is in the form of structural roof cladding. More preferably said cladding is cold roll formed from strip metal.

Preferably the rigid panel backing is fabricated from metal. More preferably said backing is cold roll formed from strip metal.

### BRIEF DESCRIPTION OF THE DRAWINGS

In order to achieve a better understanding of the nature of the present invention a preferred embodiment of a solar roof assembly and other aspects of the invention will now be described, by way of example only, with reference to the accompanying drawings in which:

FIG. 1 is a perspective view of a solar roof assembly according to an embodiment of one aspect of the invention;

FIG. 2 is an enlarged side view taken front the solar roof assembly of FIG. 1;

FIGS. 3A and 3B are perspective views of alternate embodiments of a securement device such as that used in FIGS. 1 and 2 for securing a pair of adjacent solar panels directly to roof cladding according to another aspect of the invention; and

FIG. 4 is a schematic perspective view of another embodiment of a securement device for securing a solar panel directly to roof cladding according to this other aspect of the invention;

FIG. 5 is a perspective view of a solar roof assembly according to an embodiment of another aspect of the invention.

### DETAILED DESCRIPTION OF THE PREFERRED EMBODIMENTS

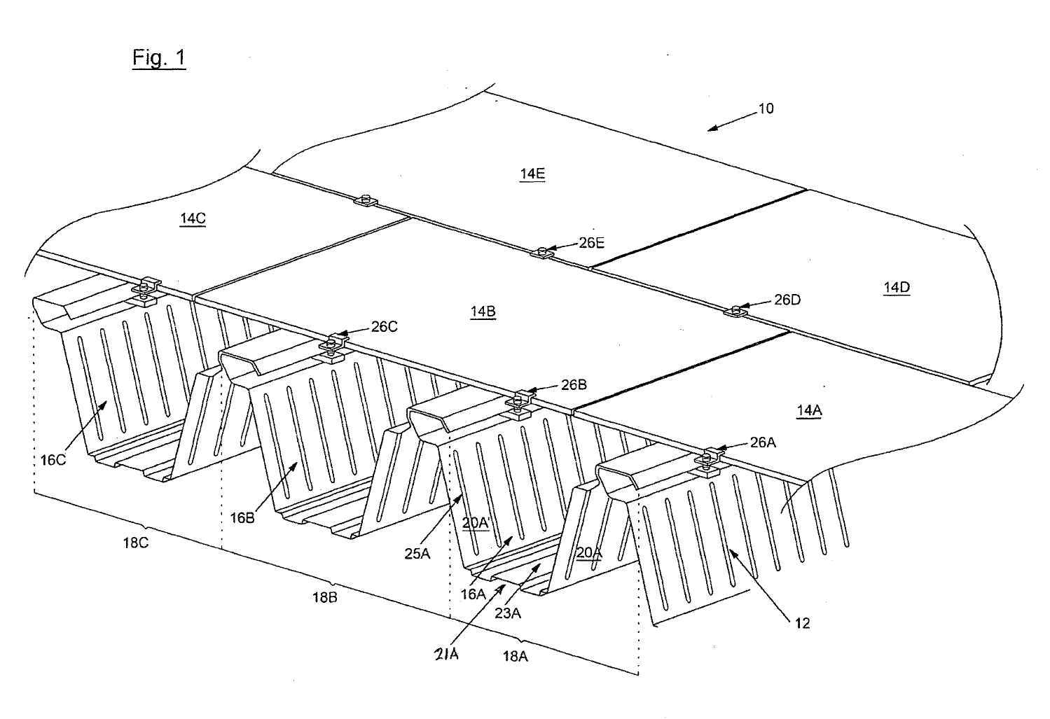

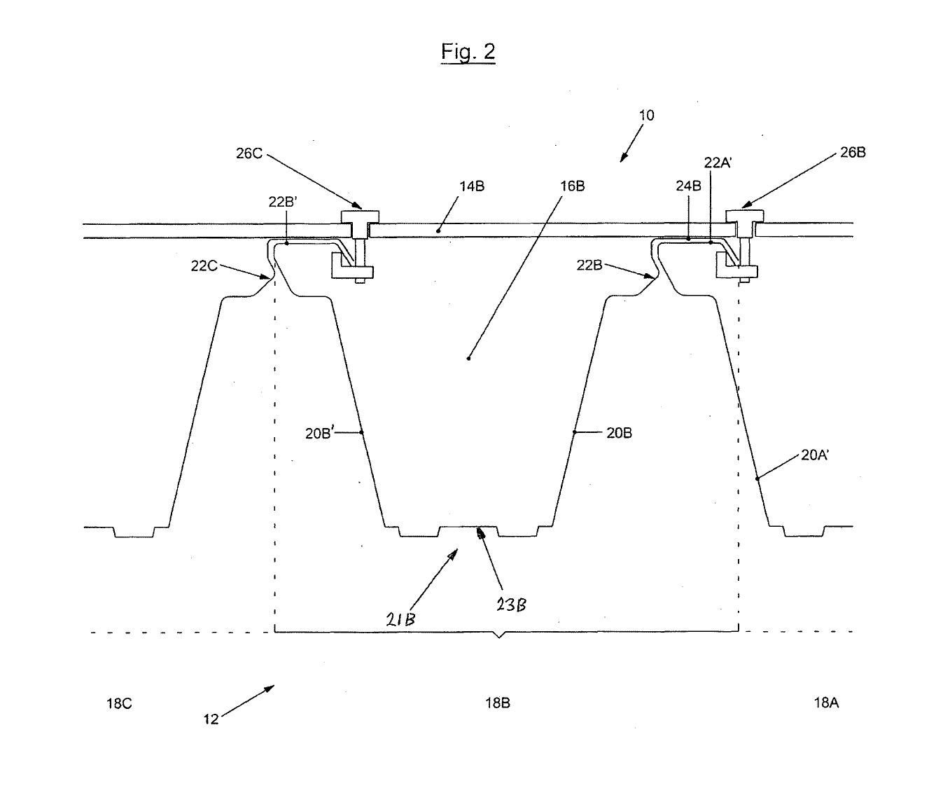

As best shown in FIGS. 1 and 2 there is a solar roof assembly designated generally as 10 comprising roof cladding 12, and a plurality of solar panels such as 14A to 14F. The solar roof assembly 10 is in this example installed on a functional roof including purlins, rafters or other structural members (not shown) to which the roof cladding 12 is fixed.

In this embodiment the roof cladding 12 is structural roof cladding which includes a series of adjacent channels such as 16A to 16C. The solar panels 14A to 14F are secured directly to the structural roof cladding 12 to substantially enclose the channels 16A to 16C. The solar panels 14A to 14F in this example provide substantially complete coverage of the structural roof cladding 12 which it will be appreciated is illustrated in part only. However, the solar panels such as 14A may also provide only partial coverage of the roof cladding 12.

The structural roof cladding 12 of this embodiment includes a plurality of elongate cladding panels such as 18A to 18C each defining the respective channel 16A to 16C Each of the cladding panels such as 18A includes a pair of inclined side walls 20A/20A′ interconnected by an intermediate pan 21A. The cladding panels such as 18A are in this example in cross-section generally trapezoidal-shaped. The pan 21A is provided with longitudinally extending strengthening ribs such as 23A. The side walls such as 20A are provided with transverse corrugations such as 25A. These design features in combination provide the cladding panels such as 18A with additional rigidity and effectiveness as structural roof cladding.

As best shown in FIG. 2 the cladding panels such as 18B each include a flange such as 22B extending from a free edge margin of the side wall such as 20B. The cladding panel 18B is adjoined with adjacent cladding panels 18A and 18C. This it effected by interlocking of the adjacent flanges such as 22A′ and 22B. In this example the male flange 22A′ of the cladding panel 18A nest within the female flange 22B of the adjacent cladding panel 18B. The opposite male flange 22B′ of the cladding panel 18B′ nests within the fomale flange 22C of the cladding panel 18C.

The interlocked flanges such as 22A′/22B form a platform such as 24B on which the solar panel such as 14B directly rests. The solar panel 14B is secured directly to the roof cladding 12 via a securement device such as 26B or 26C according to another aspect of the invention. The securement device 26B/26C engages the roof cladding 12 without penetration of its cladding panels such as 18A to 18C for clamping of the solar panel such as 14B directly to the roof cladding 12.

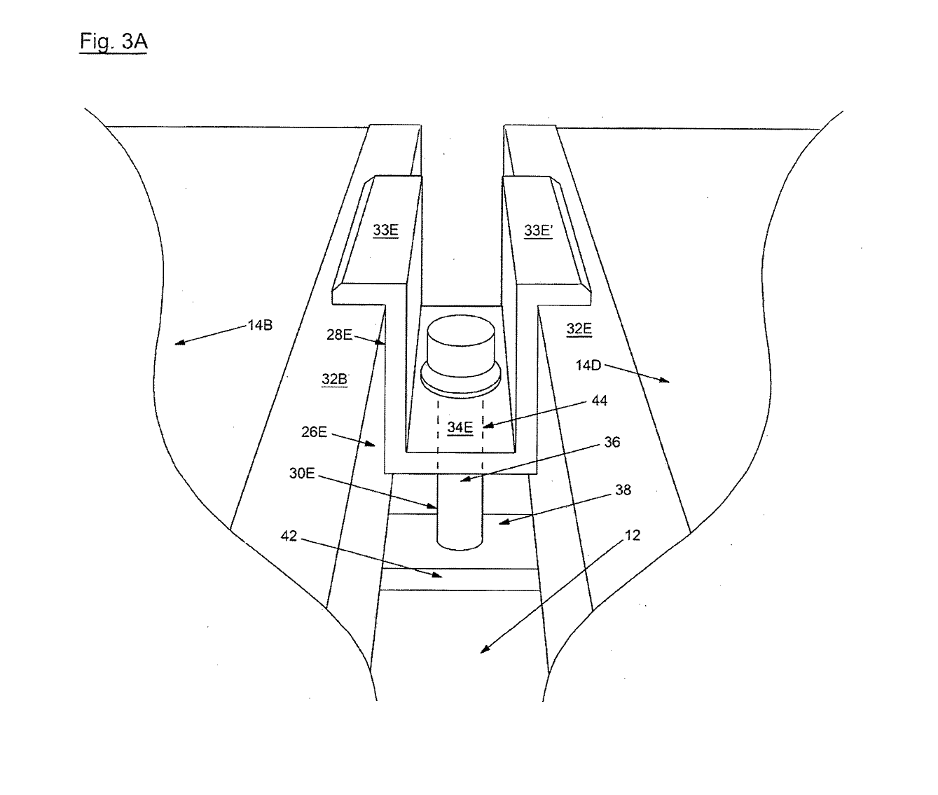

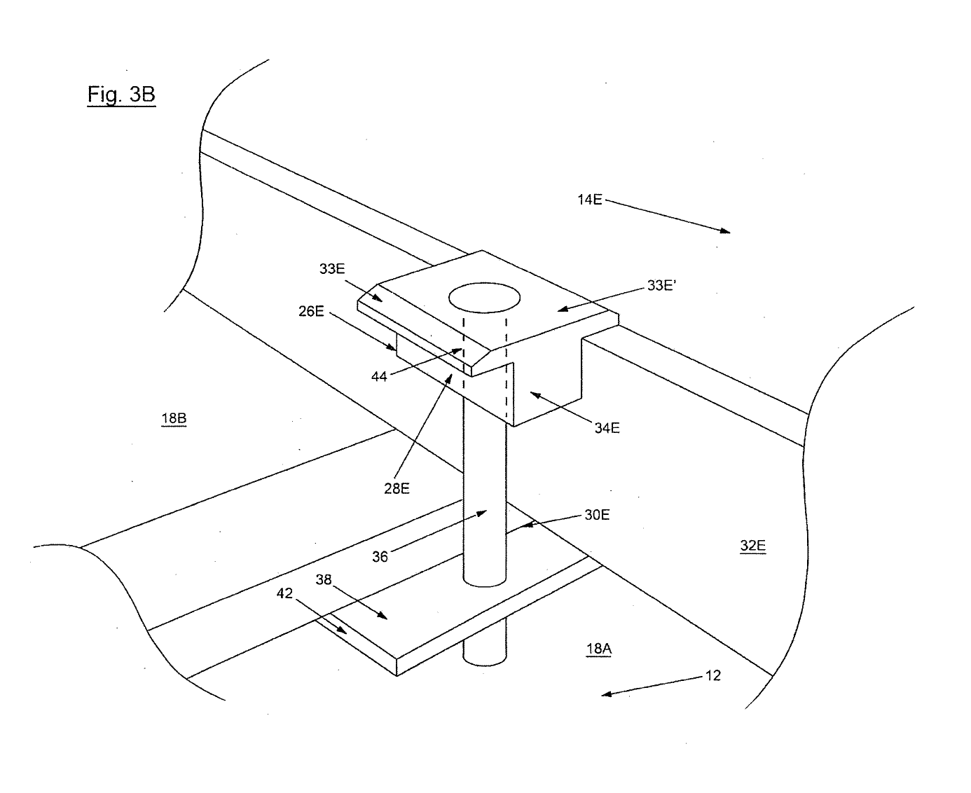

As shown in FIGS. 3A and 3B the securement device such as 26E comprises a hold down fitting 28E and a fastening arrangement 30E operatively coupled to one another for clamping the adjacent solar panels such 14B/14D directly to the roof cladding 12. The hold down fitting 28E is adapted to engage adjacent perimeter frames 32B and 32D of the solar panels 14B and 14D respectively. The fastening arrangement 30E is in this embodiment adapted to engage the roof cladding 12 without penetration. The hold down fitting 28E is in the embodiment of FIG. 3A U-shaped in cross-section whereas in the embodiment of FIG. 3B it is generally T-shaped. In either case the hold down fitting such as 28E includes a pair of gripping flanges 33E and 33E′ extending either side of a fastener mount 34E.

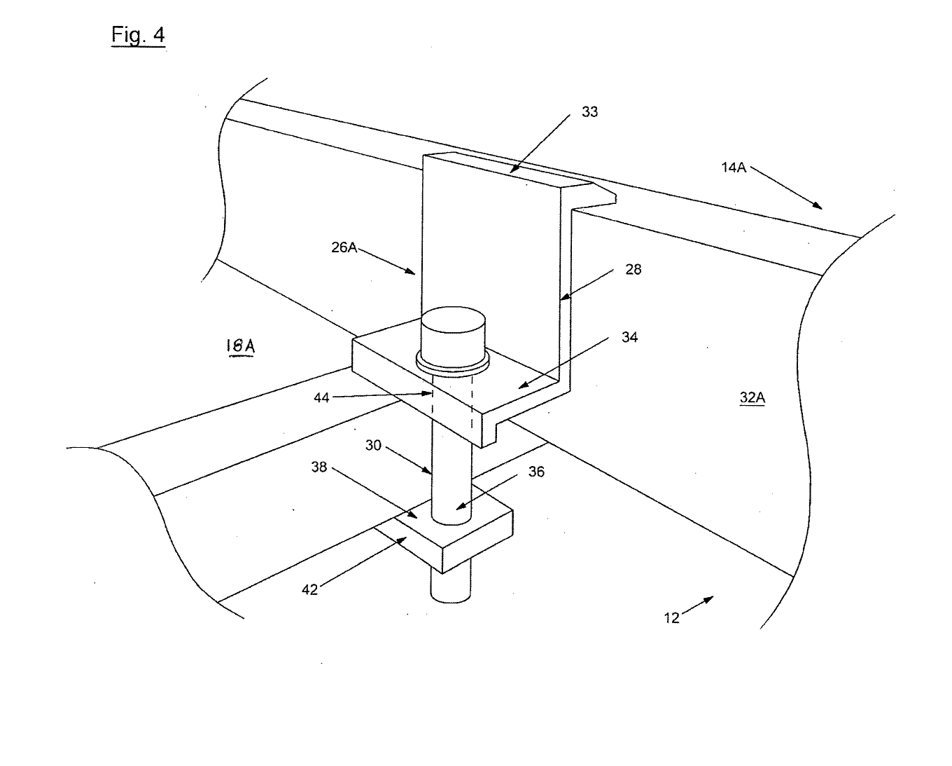

As shown in FIG. 4 this alternate securement device designated as 26A is designed to secure a solar panel such as 14A located at or adjacent the perimeter of the roof structure directly to the roof cladding such as 12. For case of reference and to avoid repetition, similar components of this securement device 26A have been designed with the same reference numeral as the previous embodiments. The hold down fitting 280 is generally Z-shaped in cross-section with its lower flange forming the fastener body 34.

The securement devices of FIGS. 3 and 4 each include the fastening arrangement 30 of similar construction. The fastening arrangement such as 30 includes a threaded bolt 36 arranged at its threaded end to screw threadably engage a cleat 38 configured to engage the roof cladding 12. The cleat 38 includes a raised flange 40 arranged to engage the interlocked flanges such as 22A′ and 22B of adjoining panels 18A and 18B. The cleat 38 includes an adjoining foot 42 threaded for mating engagement with the bolt 36. The bolt 36 passes through an aperture 44E formed in the fastener body 34E of the hold down fitting such as 26E. The head of the bolt 36 bears against the hold down fitting 26E for clamping of the solar panels 14A and 14D to the roof cladding 12 via the securement device 26E.

The plurality of solar panels such as 14A to 14F together with the roof cladding 12 define a still air gap within at least one of the-channels 16A to 16C. The still air gap such as 16B has a thermal insulating effect for the solar roof assembly 10. The trapezoidal-shaped cladding panels such as 18A allows a greater volume of air to be enclosed in the still air gap or channel such as 16A than, for example, a sinusoidal-shaped cross-section does. This is expected to improve the thermal insulating effect of the solar roof assembly such as 10. At an ambient temperature of around 35° the solar roof assembly 10 is estimated to lower the interior temperature by up to around 10°. In addition to its thermal insulation properties the solar roof assembly 10 is also expected to provide effective acoustic or noise insulation.

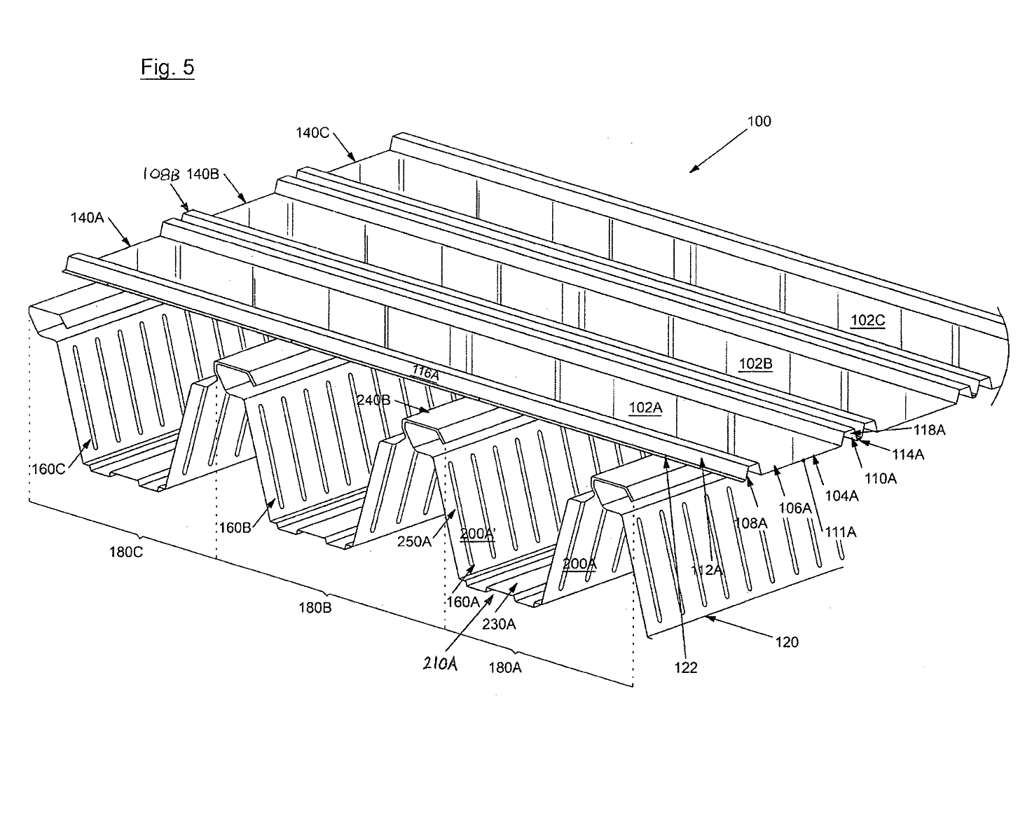

FIG. 5 illustrates another aspect of the composite roof 100 where the solar panels such as 140A include a thin film PV membrane 102A applied to a rigid panel backing 104A. The panel backing 104A of this example includes an intermediate trough 106A and adjacent ridges 108A and 110A extending parallel to and on either side of the trough 106A. The trough 106A is in section shaped trapezoidal with its intermediate pan 111A extended relative to the adjacent trapezoidal shaped ridges 108A/110A. The panel backing 106A includes flanges 112A/114A extending from the respective inclined side walls 116A and 113A of the ridges 106A and 110A. The flanges 112A and 114A are designed to be directly screw fastened to the platform 240B of the underlying cladding panels such as 180A to 180C. This penetration such as 122 does not compromise the waterproofing of the roof cladding such as 180B. It will be understood that the solar panel 104A is one of a series of adjacent panels arranged adjacent to one another to substantially enclose the underlying structural roof cladding 120. The flanges such as 112A of adjacent panels such as panels 140A lap one another and are screw fastened into the roof cladding 120 via a common screw fastener (not shown).

The rigid panel 104A and its associated thin film PV membrane 102A are oriented with the trough 106A and ridges 108A/110A substantially perpendicular to the channels 1606 of the cladding such as 180B. The panel backing 104A is inherently rigid and serves to cross brace the roof cladding such as 180B. The profile may also be designed so that shading is minimised to enhance the exposure of the associated thin film PV membrane 102A. The membrane 102A in this embodiment is applied to the intermediate pan 111A only although it can also extend substantially all of the rigid panel backing 104A. Like components of this other embodiment have been designated with an additional “0” where for example the roof cladding is 120.

In the embodiment of FIG. 5 the flanges such as 114A end 112B overlap and are screw fastened to the underlying platform such as 240B of the roof cladding 120. This means the entire pan such as 111A of the rigid panel backing 104A is available for covering with the thin film PV membrane 102A. In an alternative embodiment the ridges such as 110A and 108B may overlap or nest within one another so that the rigid panel backing such as 104A is fastened through its pan 111A to the underlying platform such as 240B. This means the nested solar panels such as 140A and 140B are more effective in preventing the ingress of water to the underlying roof cladding 120.

The rigid panel backing 104A is cold roll formed from strip metal in-situ using a roll former (not shown). The solar panels may also be assembled in-situ where the thin film PV membrane 102A is applied to the rigid panel backing such as 104A. The panel 104A is in this embodiment cold roll formed from strip metal. The PV membrane 102A may be adhered to the panel 104A downstream of its roll forming and prior to direct fastening of the panel backing 104A to the roof cladding such as 18B. Alternatively the panel backing 104A may be screw fastened to the roof cladding such as 18B and thereafter the PV membrane 102A or coating applied.

In another aspect of the invention there is a method of insulating a roof having roof cladding such as that described in the previous embodiment. In this aspect the method may involve construction of the entire roof structure and the associated building where its roof cladding such as 12 is at least partly covered in solar panels such as 14A to 14F directly secured to the roof cladding 12 to substantially enclose its channels such as 16A to 16C. In a variation on this aspect of the methodology it is possible that an existing roof structure having structural roof cladding is at least partly covered with solar panels such as 14A to 14C. In either case this method effectively insulates the roof structure.

In a further aspect of the invention there is a method of heating or cooling a building (not illustrated) having roof cladding such as that described in the context of the earlier embodiment. The general steps involved in this method comprise:

1. Securing a plurality of solar panels such as 14A to 14F directly to structural roof cladding such as 12 to substantially enclose channels 16A to 16C of the roof cladding 12 for at least partial coverage of the roof cladding 12;

2. Extracting stir from at least one of the enclosed channels such as 16A for heating or cooling of the building.

In this embodiment the step of securing the solar panels such as 14A directly to the roof cladding 12 involves securing a perimeter frame 32A of the solar panel such as 14A to the roof cladding 12 without penetrating the cladding 12. The securement device such as 26 of the earlier embodiments may be used for this purpose.

It is expected that the perimeter frame of the solar panels such as 14A to 14C will act as cross-brace for the cladding panel such as 13B to which it is secured. The solar panels such as 14A and 14E are staggered in adjacent rows so that a plurality of the solar panels such as 14A to 14F are laid in a staggered arrangement similar to bricks in a wall. The means that solar panel 14B effectively cross braces cladding panel 18B whereas solar panel 14E from the adjacent row cross braces cladding panel 18A. This staggered arrangement ensures that each of the cladding panels such as 18A and 18B are cross-braced via a solar panel from at least every other (or alternate) rows of solar panels. That is, the solar panel such as 14B and its associated perimeter frame 32B bridges the channel such as 16B of the cladding panel 18B to strengthen it transversely.

The securement devices such as 260 or 26E of this embodiment are designed to locate anywhere along the cladding panels such as 18B wherein the interlocked flanges such as 22A′ and 22B operate as a mounting rail. The securement device such as 26E can also engage the perimeter frame 32B of the solar panel 14B practically anywhere along its length without requiring specific positioning or alignment. This means the solar panels such as 14A to 14F can be positioned on the underlying structural roof cladding in a relatively random manner without requiring relative alignment or positioning. The clamping of the solar panel such as 14A to the roof cladding 12 without penetration also means that the strength or waterproofing of the roof cladding 12 is not compromised.

The method of heating or cooling the building may also comprise the step of diverting the extracted hot air into an enclosed apace of the building for healing of the enclosed space (not shown). The method may also be automated where the temperature in the enclosed space is measured and the extracted air diverted into either:

1. the atmosphere in the event that the detected temperature is above a predetermined set point temperature, or

2. the enclosed space of the building in the event that the detected temperature is below the set point temperature.

This automatic control may be implemented by using a convention thermostat control end valve arrangement. The predetermined set point temperature may vary from between 20° to 30°. The thermal convection within the still air gap of the channels such as 16A of the solar roof assembly 10 can produce a chimney effect for expelling hot air from the enclosed channels. Alternatively or additionally the method may involve one or more extraction fans operatively coupled to the enclosed channels and possibly powered by the solar panels. In any case the relatively large channels such as 18A to 16C of the roof cladding 12 of this embodiment lend themselves to thermodynamic heating or cooling utilising the still air gap.

The solar roof assembly may, depending on the climatic conditions in which it is installed, include sealing strips (not shown). These sealing strips are located between adjacent of the solar panels such as 14A end 14D to substantially seal the gap between these panels. Instead of sealing adjacent solar panels with sealing strips they may be arranged in abutment with one another. In this configuration the solar panels are secured directly to the roof cladding from underneath. For example, the solar panels may be screw fastened to the roof cladding such as 12 using for example TEKS® screws. These screws may for example be self-drilled through interlocked flanges of adjoining panels directly into the perimeter frame of the solar panel. In this installation there is no requirement for a securement device such as that described in the earlier embodiment. Alternatively and typically in temperate climates, there may be benefit in not completely sealing adjacent solar panels to allow venting of the still air gap.

The solar panels of this embodiment are each solar photovoltaic (PV) panels having a toughened glass upper layer. The PV panels of this construction are sufficiently robust to permit pedestrian access across the solar panels without damaging them. In the context of the solar roof assembly with its substantially complete coverage this is important because access need not then be provided by walkways along the roof cladding itself. This means the entire roof cladding can be covered with solar panels to enable maximum energy to be harnessed from the solar roof structure.

Now that a preferred embodiment of the present invention has been described in some detail it will be apparent to those skilled in the art that the solar roof assembly at least in its preferred embodiments has the following advantages:

1. It provides a composite roof providing both thermal insulation and the ability to generate power or heating via its solar panels;

2. The method of heating or cooling a building utilises the relatively large still air gap created by the blanket coverage of the solar panels across the roof cladding;

3. The solar panels can be secured directly to the roof cladding without requiring complicated and expansive mounting structures;

4. The method and its various components allow for location of the solar panels practically anywhere across the roof cladding which itself provides mounting or hold down rails.

Those skilled in the will appreciate that the invention described herein is susceptible to variations and modifications other than those specifically described. The PV membrane need not be limited to thin film PV but may extend to coatings such as those used in dye solar cell technology. For example, the securement device may vary from the preferred embodiments where it penetrates interlocked or other portions of the roof cladding without significantly compromising its integrity. All such variations and modifications are to be considered within the scope of the present invention the nature of which is to be determined from the foregoing description.

1. A solar roof assembly comprising:
roof cladding including at least one channel,
a plurality of solar panels secured directly to the roof cladding to substantially enclose said at least one channel for at least partial coverage of the roof cladding, each of the solar panels including a rigid panel backing to which a photovoltaic membrane or coating is applied.

2. A solar roof assembly as defined in claim 1 wherein the rigid panel backing includes an intermediate pan located between opposing ridges wherein the panel backing is secured directly to the roof cladding with said ridges disposed transverse to the channel of the roof cladding thereby cross-bracing it

3. A solar roof assembly as defined in claim 2 wherein the adjacent solar panels lap one another and are both screw fastened to the roof cladding via a common screw fastener.

4. A solar roof assembly as defined in either of claim 2 or 3 wherein the PV membrane or coating extends across at least substantially all of the pan of the rigid panel backing.

5. A solar roof assembly as defined in any one of the preceding claims wherein the plurality of solar panels together with the roof cladding define a still air gap within said at least one channel.

6. A solar roof assembly as defined in claim 5 wherein the still air gap has a thermal insulating effect for the solar roof assembly.

7. A solar roof assembly as defined in any one of the preceding claims wherein the roof cladding includes a plurality of elongate cladding panels each including said at least one channel with adjacent of the panels being adjoined to one another.

8. A solar roof assembly as defined in claim 7 wherein each of the cladding panels includes a pair of inclined side walls interconnected by an intermediate pan.

9. A solar roof assembly as defined in claim 8 wherein the cladding panels are each in cross-section generally trapezoidal-shaped.

10. A solar roof assembly as defined in any one of claims 7 to 9 wherein the cladding panels each include a flange extending from a free edge margin of respective of the side walls.

11. A solar roof assembly as defined in claim 10 wherein adjacent of the flanges of adjoining panels are configured to interlock.

12. A solar roof assembly as defined in claim 11 wherein one of the interlocked flanges forms a platform on which the solar panel rests.

13. A solar roof assembly comprising:
roof cladding including at least one channel;
a plurality of solar panels secured directly to the roof cladding to substantially enclose said at least one channel for at least partial coverage of the roof cladding;
a plurality of securement devices each including a hold down fitting configured to engage a perimeter frame of at least one of the solar panels, and a fastening arrangement configured to engage the roof cladding without penetration and operatively coupled to the fluid down fitting for clamping of the solar panel directly to the roof cladding.

14. A solar roof assembly as defined in claim 14 wherein the plurality of solar panels together with the roof cladding define a still air gap within said at least one channel.

15. A solar roof assembly as defined in claim 14 wherein the still air gap has a thermal insulating effect for the solar roof assembly.

16. A solar roof assembly as defined in any one of claims 13 to 15 the roof cladding includes a plurality of elongate cladding panels each including said at least one channel with adjacent of the panels being adjoined to one another.

17. A solar roof assembly as defined in claim 16 wherein each of the cladding panels includes a pair of inclined side walls interconnected by an intermediate pan.

18. A solar roof assembly as defined in claim 17 wherein the cladding panels are each in cross-section generally trapezoidal-shaped.

19. A solar roof assembly as defined in any one of claims 16 to 18 wherein the cladding panels each include a flange extending from a free edge margin of respective of the side walls.

20. A solar roof assembly as defined in claim 19 wherein adjacent of the flanges of adjoining panels are configured to interlock.

21. A solar roof assembly as defined in claim 20 wherein one of the interlocked flanges forms a platform on which the solar panel rests.

22. A solar roof assembly as defined in any one of claims 16 to 21 wherein the solar panels are each solar PV panels having a toughened glass upper layer.

23. A solar roof assembly as defined in claim 22 wherein the solar PV panels are secured to the root cladding in one or more rows located alongside one another and oriented substantially transverse to the channels of the roof cladding.

24. A solar roof assembly as defined in claim 23 wherein adjacent rows of the solar panels are staggered relative to one another.

25. A solar roof assembly as defined in any one of claims 16 to 24 wherein the solar panel acts as a cross-brace for the cladding panel to which it is secured.

26. A solar roof assembly as defined in claim 25 wherein the cross-brace bridges and is oriented transverse to the channel of the roof cladding.

27. A method of insulating a roof having roof cladding, said method comprising the steps of:
securing a plurality of solar panels directly to the root cladding to substantially enclose channels of the roof cladding for at least partial coverage of said roof cladding;
clamping each of the solar panels directly to the roof cladding via a securernent device without penetration of the roof cladding.

28. A securement device for securing a solar panel directly to roof cladding, the securement device comprising:
a hold down fitting adapted to engage a perimeter frame of the solar panel;
a fastening arrangement adapted to engage the roof cladding without penetration and operatively coupled to the hold down fitting for clamping the solar panel directly to the roof cladding.

29. A securement device as defined in claim 28 wherein the fastening arrangement includes a screw threaded bolt arranged at its head to engage the hold down fitting and arranged at its threaded end to screw threadably engage a cleat configured to engage the roof cladding.

30. A securernent device as defined in claim 29 wherein the cleat includes a raised flange arranged to engage interlocked flanges of adjoining cladding panels for clamping of the solar panel to said cladding panels.

31. A method of heating or cooling a building having roof cladding, said method comprising the steps of:
securing a plurality of solar panels directly to the roof cladding to substantially enclose channels of the roof cladding for at least partial coverage of said roof cladding;
extracting air from at least one of the enclosed channels of the roof cladding for heating or cooling of the building.

32. A method of treating or cooling as defined in claim 31 also comprising the step of diverting the extracted air into an enclosed space of the building for heating of the enclosed space.

33. A method of heating or cooling as defined as defined in claim 32 further comprising the steps of:
detecting the temperature in the enclosed space of the building;
diverting the extracted air into either:
(i) the atmosphere in the event that the detected temperature is above a predetermined set point temperature; or (ii) the enclosed space of the building in the event that the detected temperature is below the set point temperature.

34. A solar roof assembly as defined in any one of claims 1 to 12 wherein the rigid panel backing is fabricated from metal.

35. A solar roof assembly as defined in claim 34 wherein said backing is cold roll formed from strip metal.

36. A solar roof assembly as defined in any one of claims 1 to 26 wherein the roof cladding is fabricated from metal and is in the form of structural roof cladding.

37. A solar roof assembly as defined in claim 36 wherein said cladding is cold roll formed from strip metal.
